(19) United States
(12) Patent Application Publication
(10) Pub. No.: US 2025/0126215 A1
(43) Pub. Date: Apr. 17, 2025

(54) IMAGE FORMING SYSTEM

(71) Applicant: FUJIFILM Business Innovation Corp., Tokyo (JP)

(72) Inventor: Masahiko YAMAMOTO, Kanagawa (JP)

(73) Assignee: FUJIFILM Business Innovation Corp., Tokyo (JP)

(21) Appl. No.: 18/639,493

(22) Filed: Apr. 18, 2024

(30) Foreign Application Priority Data
Oct. 12, 2023 (JP) 2023-176965

(51) Int. Cl. H04N 1/00

(52) U.S. Cl. CPC H04N 1/00557; H04N 1/00392; H04N 1/00631

(57) ABSTRACT

An image forming system includes a body portion including an image forming section that forms an image on a medium; an image input section that inputs an image and is provided on an upper side of the body portion in an up-down direction; a reading section that reads information stored in a storage medium and is provided in an inclined portion that straddles the body portion and the image input section and is inclined with a rising gradient from a front side that corresponds to a front surface of the body portion toward a rear side; and an operation section that receives an operation by an operator, is disposed at a position adjacent to the reading section with an operation surface disposed along an outer side surface of the reading section, and has a color similar to a color of the outer side surface of the reading section.

### CROSS-REFERENCE TO RELATED APPLICATIONS

This application is based on and claims priority under 35 USC 119 from Japanese Patent Application No. 2023-176965 filed Oct. 12, 2023.

### BACKGROUND

### (i) Technical Field

The present disclosure relates to an image forming system.

### (ii) Related Art

Japanese Unexamined Patent Application Publication No. 2018-61182 discloses an image forming apparatus including a reading section that reads an image and an image forming section that forms an image on a recording medium, both of which are accommodated inside an exterior member. The image forming apparatus includes an operation display that is disposed in front of the reading section, receives an operation by an operator, and displays an image for a user. The operation display is provided so as to be rotatable between a position in which the operation display faces an upper side of the image forming apparatus and a position in which the operation display faces a front side of the operation display with a center of rotation disposed on the front side. The exterior member has an outer surface that is a background behind the operation display in a front view. The outer surface is colored in a color similar to a color of an outer surface of the operation display.

### SUMMARY

Aspects of non-limiting embodiments of the present disclosure relate to an image forming system that can intuitively convey to an operator an area where operator operation is required, compared to a case where a reading section that reads information from a storage medium is positioned lower than an operation section and the color of an outer side surface of the reading section and the color of the operation section are different from each other.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including: a body portion including an image forming section that forms an image on a medium; an image input section that inputs an image, the image input section being provided on an upper side of the body portion in an up-down direction; a reading section that reads information stored in a storage medium, the reading section being provided in an inclined portion that straddles the body portion and the image input section, the inclined portion being inclined with a rising gradient from a front side that corresponds to a front surface of the body portion toward a rear side; and an operation section that receives an operation by an operator, the operation section being disposed at a position adjacent to the reading section with an operation surface disposed along an outer side surface of the reading section, the operation section having a color similar to a color of the outer side surface of the reading section.

### BRIEF DESCRIPTION OF THE DRAWINGS

An exemplary embodiment of the present disclosure will be described in detail based on the following figures, wherein:

FIG. 1 is a perspective view illustrating an example of an image forming system according to a first exemplary embodiment;

FIG. 2 is a front view illustrating a part of the image forming system according to the first exemplary embodiment;

FIG. 3 is a front view illustrating a vicinity of an operation panel and an IC card reader in the image forming system according to the first exemplary embodiment;

FIG. 4 is a perspective view illustrating an image forming system according to a first comparative example; and

FIG. 5 is a perspective view illustrating an image forming system according to a second comparative example.

### DETAILED DESCRIPTION

Hereinafter, an example according to an exemplary embodiment of the present disclosure will be described with reference to the drawings. Note that, in each of the drawings, an arrow H indicates a vertical direction, that is, an up-down direction of an apparatus, an arrow W indicates a horizontal direction, that is, a width direction of the apparatus, and an arrow D indicates a front-rear direction of the apparatus (depth direction of the apparatus).

### First Exemplary Embodiment

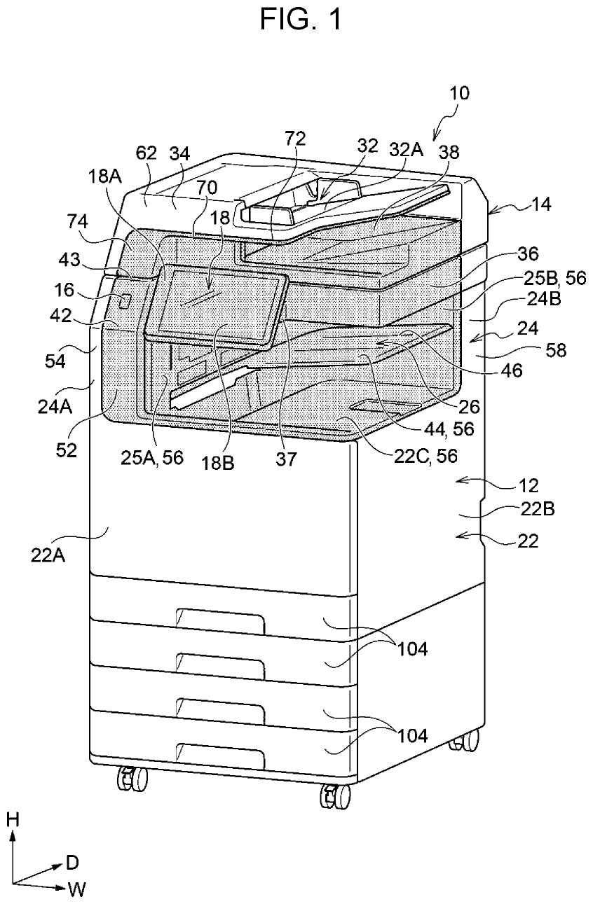

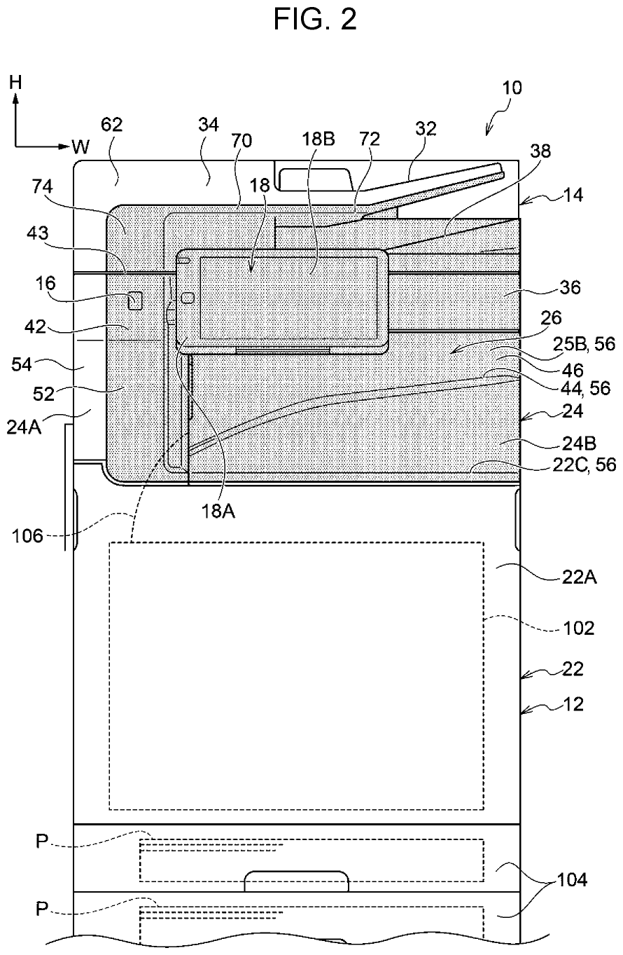

FIG. 1 is a perspective view illustrating an image forming system 10 according to a first exemplary embodiment, and FIG. 2 is a front view illustrating a part of the image forming system 10.

### [Overall Configuration of Image Forming System]

The image forming system 10 illustrated in FIGS. 1 and 2 is an image forming system that forms a toner image on a medium. FIG. 1 illustrates a front surface side (that is, a front side), a right side in the width direction (W direction), and an upper surface side of the image forming system 10. FIG. 2 illustrates the front surface side (that is, the front side) of the image forming system 10.

As illustrated in FIGS. 1 and 2, the image forming system 10 includes a body portion 12 and a document reading device 14. The body portion 12 is a body of the image forming system. The document reading device 14 is provided on an upper side of the body portion 12 in the up-down direction (H direction) and reads a document. The document reading device 14 includes an image input section 36 on a lower side of an automatic document feeding section 34 described later. The image input section 36 inputs an image. Furthermore, the image forming system 10 includes an IC card reader 16 and an operation panel 18. The IC card reader 16 is provided in an inclined portion 42, which will be described later, straddling the body portion 12 and the image input section 36. The operation panel 18 receives a user operation. The IC card reader 16 is an example of a reading section. The operation panel 18 is an example of an operation section.

### (Body Portion)

The body portion 12 includes an image forming section 102 inside a housing 22 described later. The image forming section 102 forms an image on a medium P such as a sheet (see FIG. 2). A plurality of (for example, four) medium accommodation sections 104 are provided on a lower portion side of the body portion 12. The medium accommodation section 104 accommodates media P. Each of the plurality of medium accommodation sections 104 can be pulled out toward the front side with respect to the housing 22 of the body portion 12, allowing for replenishment of media P into the medium accommodation section 104 in a state of being pulled out. For example, different types of media P are accommodated in the plurality of medium accommodation sections 104. For example, the image forming section 102 transports the medium P accommodated in any one of the plurality of medium accommodation sections 104 one by one, and forms an image on the medium Pby an electrophotographic method. Note that the image forming section 102 is not limited to one using the electrophotographic method, and may form an image on the medium P by an ink ejection method in which ink as droplets are ejected, for example.

As illustrated in FIGS. 1 and 2, the body portion 12 includes the housing 22 having a rectangular parallelepiped shape and a support portion 24 extending upward from an upper portion of the housing 22. The document reading device 14 is disposed on the upper side of the support portion 24. The image input section 36 provided on the lower portion of the document reading device 14 is connected to the support portion 24. The document reading device 14 is supported by the support portion 24. In a state of being viewed from the front surface side of the image forming system 10, the support portion 24 is disposed so as to surround a space above the housing 22 from a left side in the width direction (W direction) and a deep side in the depth direction (D direction) of the housing 22. Specifically, the support portion 24 includes a side portion 24A and a rear surface portion 24B. The side portion 24A is disposed along the side surface of the housing 22 on the left side in the width direction (W direction). The rear surface portion 24B is disposed along a rear surface of the housing 22 on the deep side in the depth direction (D direction).

The image forming system 10 includes a discharge section 26 on a lower side of the image input section 36 in the body portion 12. A medium P on which an image is formed by the image forming section 102 (see FIG. 2) is discharged to the discharge section 26. Inside the body portion 12, a transport path 106 (see FIG. 2) through which the medium P is transported from the image forming section 102 to the discharge section 26 is provided. As an example, the discharge section 26 is provided in the space surrounded by the side portion 24A and the rear surface portion 24B of the support portion 24 (see FIG. 1). The configuration of the discharge section 26 will be described later.

### (Document Reading Device)

The document reading device 14 includes a document placement section 32, the automatic document feeding section 34, the image input section 36, and a document discharge section 38. The document placement section 32 includes a document tray 32A on which documents are stacked. The automatic document feeding section 34 is an example of a document feeding device. The automatic document feeding section 34 feeds the documents placed on the document placement section 32 to the document discharge section 38 via the image input section 36. More specifically, the automatic document feeding section 34 takes out the documents stacked on the document tray 32A of the document placement section 32 in order from the top, and transports the documents one by one to the image input section 36.

The image input section 36 has a function of inputting an image by reading a document or the like. More specifically, the image input section 36 optically reads an image on the document transported by the automatic document feeding section 34 and converts the image into image data as an electric signal. As a result, the image input section 36 inputs the image on the document as image data.

The document input as image data by the image input section 36 is discharged to the document discharge section 38 provided below the document placement section 32 by the automatic document feeding section 34.

The automatic document feeding section 34 is configured to be openable and closable between a position in which an input unit that receives an image to be input to the image input section 36 is closed (see FIG. 1) and a position in which the input unit is opened. In the image forming system 10, as an example, a dividing line 43 that divides the image input section 36 and the automatic document feeding section 34 in the inclined portion 42 is provided. The automatic document feeding section 34 on the upper side of the dividing line 43 is configured to be openable and closable with respect to the image input section 36. Although not illustrated, the input unit includes a glass surface on which a document is directly placed when the automatic document feeding section 34 is not used. The image input section 36 reads the document placed on the glass surface and inputs the document as image data.

In the first exemplary embodiment, the automatic document feeding section 34 is integrated with the document placement section 32 and the document discharge section 38, and is configured to be openable and closable so as to open upward with respect to the image input section 36. As an example, the automatic document feeding section 34, the document placement section 32, and the document discharge section 38 are configured such that the front side opens upward with respect to the image input section 36 about a hinge disposed along the width direction (W direction) on the deep side of the image input section 36 in the depth direction (D direction). Note that the document tray 32A may be configured such that the right side in the width direction (W direction) rotates upward with respect to the automatic document feeding section 34 in a state where the left side in the width direction (W direction) is rotatably supported by the automatic document feeding section 34.

The front side of the automatic document feeding section 34 in the depth direction (D direction) is provided with a gripping portion 70 that is capable of being gripped when a user opens the automatic document feeding section 34. The gripping portion 70 and an edge portion 72 on the front side of the automatic document feeding section 34 in the depth direction (D direction) are continuously connected in a linear shape. With this configuration, when the user opens the automatic document feeding section 34, the user can grip a wide range, formed by the gripping portion 70 and the edge portion 72 connected to the gripping portion 70. The edge portion 72 of the automatic document feeding section 34 is cut out so as to be curved toward the deep side in the depth direction (D direction) from the vicinity of the center portion of the automatic document feeding section 34 to the right side in the width direction (W direction). With this configuration, a portion of the document discharge section 38 on the right side in the width direction (W direction) is exposed, and the document can be taken out through the exposed portion.

### (IC Card Reader)

The IC card reader 16 has a function of reading information stored in an IC card as an example of an information medium. The IC card refers to a card in which an integrated circuit (IC) chip is embedded. The IC card reader is a device that reads a card in which an IC chip is incorporated. For example, information for identifying an owner is stored in the IC card. The information stored in the IC card can be read by the IC card reader 16 by touching the IC card to the IC card reader 16 or bringing the IC card close to the IC card reader 16. As an example, the image forming system 10 is controlled to be driven only by a predetermined owner by reading information for identifying the owner using the IC card reader 16.

The IC card reader 16 is provided in the inclined portion 42 that straddles the body portion 12 (in the first exemplary embodiment, the support portion 24 on the upper portion side) and the image input section 36. The inclined portion 42 is inclined with a rising gradient from the front side that corresponds to a front surface 22A of the housing 22 in the body portion 12 toward the rear side (that is, the deep side in the depth direction). The IC card reader 16 is provided in the inclined portion 42 and hence, an outer side surface of the IC card reader 16 is inclined with a rising gradient from the front side toward the rear side. The color of the outer side surface of the IC card reader 16 will be described later.

In the first exemplary embodiment, the image forming system 10 includes a first exterior member 52 including the outer side surface of the IC card reader 16. In a state of being viewed from the front side (that is, the front surface side) of the body portion 12, the first exterior member 52 is provided in a portion inside the side portion 24A of the support portion 24 in the width direction (W direction). The upper portion side of the first exterior member 52 includes an inner portion of the inclined portion 42 in the width direction (W direction). The color of the first exterior member 52 including the outer side surface of the IC card reader 16 will be described later.

In addition, in a state of being viewed from the front side of the body portion 12, the image forming system 10 is provided with a second exterior member 54 at a position adjacent to the left side of the first exterior member 52 in the width direction (W direction). In the first exemplary embodiment, the second exterior member 54 is provided in a range from the position adjacent to the left side of the first exterior member 52 in the width direction (W direction) to the front surface 22A (above the plurality of medium accommodation sections 104) of the housing 22. The color of the second exterior member 54 will be described later.

### (Operation Panel)

The operation panel 18 is a user interface and has a function of receiving an operation by a user. The user is an example of an operator. As an example, the operation panel 18 is, for example, a liquid crystal display, and displays various types of information to the user via the operation panel 18. In addition, the operation panel 18 employs a touch panel method, and receives an operation from a user to the touch panel, for example, receives operations, such as inputting of various settings and instructions. Note that the operation panel 18 may be provided with various operation buttons in addition to the input by the touch panel method.

As illustrated in FIGS. 1 and 2, the operation panel 18 includes, as examples, a housing 18A and an operation surface 18B provided on a front surface of the housing 18A. In the first exemplary embodiment, various types of information are displayed on the operation surface 18B of the operation panel 18, and the user performs operations, such as inputting of various settings and instructions, from the operation surface 18B. The user gives instructions from the operation surface 18B to select and execute various jobs that can be executed by the image forming system 10.

The operation panel 18 is provided on the front side (that is, the front surface side) of the image input section 36. As an example, the operation panel 18 is supported by a support portion 37 provided on the front side (that is, the front surface side) of the image input section 36. In a state of being viewed from the front side of the body portion 12, the operation panel 18 is provided at a position adjacent to the IC card reader 16 provided in the inclined portion 42. That is, the operation panel 18 and the IC card reader 16 are disposed to be adjacent to each other in the width direction (W direction) of the image forming system 10. The center portion of the operation panel 18 in the width direction (W direction) is disposed on the left side in the width direction with respect to the center portion of the image input section 36 in the width direction (W direction). That is, the operation panel 18 is disposed slightly on the left side with respect to the center portion of the image input section 36 in the width direction (W direction).

The operation surface 18B is disposed along the outer side surface of the IC card reader 16 in a state where the operation panel 18 is supported by the support portion 37 of the image input section 36. In the first exemplary embodiment, the operation surface 18B is inclined with a rising gradient from the front side that corresponds to the front surface 22A of the body portion 12 toward the rear side (that is, the deep side in the depth direction) along the outer side surface of the IC card reader 16. The color of the operation panel 18 will be described later.

Note that the operation panel 18 may be configured to be rotatably supported by the support portion 37 of the image input section 36 with a rotation axis provided along the width direction, serving as a center of rotation. With this configuration, an angle of the operation surface 18B with respect to the front surface 22A of the body portion 12 can be adjusted.

In the image forming system 10, the IC card reader 16 and the operation panel 18 are arranged in this order from left to right in the width direction (W direction) on the upper side of the body portion 12 in a state of being viewed from the front side of the body portion 12. The image forming system 10 is configured such that a series of operations for reading information from an IC card by the IC card reader 16, selecting a job by using the operation panel 18, and executing the job are performed from left to right in the width direction (W direction) of the image forming system 10. For example, the operation surface 18B of the operation panel 18 may display a job execution button on the right side in the width direction (W direction). With this configuration, the series of operations for reading information from an IC card by the IC card reader 16, selecting a job by using the operation panel 18, and executing the job are to be performed from left to right in the width direction (W direction) of the image forming system 10.

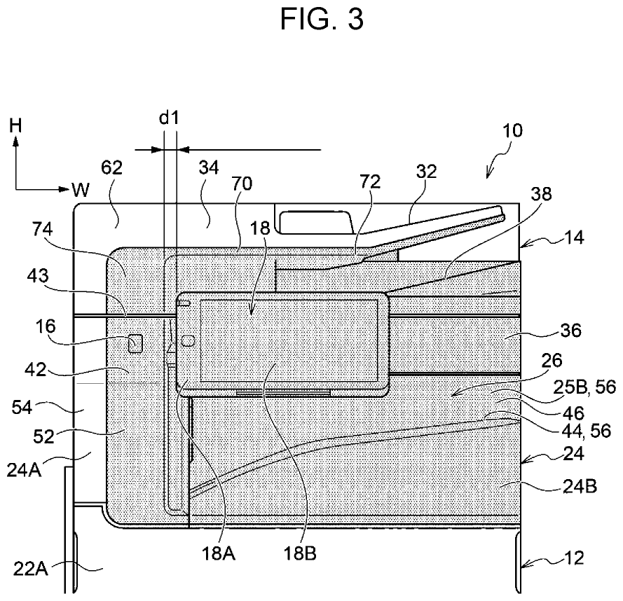

As illustrated in FIG. 3, in a state of being viewed from the front side of the body portion 12, the IC card reader 16 provided in the inclined portion 42 and the operation panel 18 are disposed at positions adjacent to each other in the width direction (W direction), and the IC card reader 16 and the operation panel 18 are disposed so as to be close to each other. An inner side surface 25A (see FIG. 1) as a vertical wall disposed along the depth direction (D direction) is provided on the right side of the inclined portion 42 in the width direction (W direction), and the operation panel 18 is provided so as to be close to the inner side surface 25A. In a state of being viewed from the front side of the body portion 12, a distance d1 between the IC card reader 16 provided in the inclined portion 42 and the operation panel 18 is preferably 15 mm or more and 20 mm or less, more preferably 15.5 mm or more and 19 mm or less, and still more preferably 16 mm or more and 18 mm or less.

### (Discharge Section)

As illustrated in FIGS. 1 and 2, as described previously, the discharge section 26 is provided on the lower side of the image input section 36 in the upper portion of the body portion 12 and in the space surrounded by the side portion 24A and the rear surface portion 24B of the support portion 24. The discharge section 26 is provided with a sheet tray 44 on which media P are stacked. The sheet tray 44 is supported by the support portion 24. As an example, in the body portion 12, a medium P is transported from the image forming section 102 to the discharge section 26 via the transport path 106 (see FIG. 2), and the medium P is discharged to the sheet tray 44 of the discharge section 26 from left to right in the width direction (W direction) of the body portion 12. The sheet tray 44 is inclined such that the right side is higher than the left side in the width direction (W direction) of the body portion 12.

In the image forming system 10, a take-out opening 46 where the medium P is taken out from the discharge section 26 is formed on the right side of the operation panel 18 in the width direction (W direction) in a state of being viewed from the front side of the body portion 12. In the first exemplary embodiment, a wall surface 56 of the discharge section 26 includes an upper surface 22C of the housing 22, the inner side surface 25A of the side portion 24A, a front side surface 25B of the rear surface portion 24B, and the sheet tray 44. The color of the wall surface 56 of the discharge section 26 will be described later.

A third exterior member 58 is provided adjacent to the discharge section 26 on the rear surface portion 24B on the rear side of the discharge section 26 in the depth direction (D direction) in the side surface of the body portion 12. In the first exemplary embodiment, the third exterior member 58 is provided in a range from a position adjacent to the discharge section 26 in the rear surface portion 24B to an intermediate portion of the side surface 22B on the right side of the housing 22 in the width direction (W direction). The color of the third exterior member 58 will be described later.

### (Color of Exterior of Image Forming System)

Here, the color of the exterior of the image forming system 10 will be described.

As illustrated in FIGS. 1 and 2, the color of the operation panel 18 (for example, the color of the housing 18A and the operation surface 18B) is similar to the color of the outer side surface of the IC card reader 16. As an example, the first exterior member 52 including the outer side surface of the IC card reader 16 has a color similar to the color of the operation panel 18 including the operation surface 18B.

As an example, the color of the outer side surface of the IC card reader 16 is black or gray. In the first exemplary embodiment, the image forming system 10 includes, as described above, the first exterior member 52 including the outer side surface of the IC card reader 16, and the color of the first exterior member 52 including the outer side surface of the IC card reader 16 is black or gray.

As described above, in a state of being viewed from the front side of the body portion 12, the second exterior member 54 is provided at the position adjacent to the left side of the first exterior member 52 in the width direction (W direction), and the color of the second exterior member 54 is different from the color of the first exterior member 52. In the first exemplary embodiment, the color of the second exterior member 54 is white or a light color with higher lightness than the color of the outer side surface of the IC card reader 16.

The lightness of an outer surface of the second exterior member 54 in Munsell value (JIS Z8721) is larger than the lightness of the operation panel 18 in Munsell value and the lightness of the outer surface of the first exterior member 52 including the outer side surface of the IC card reader 16 in Munsell value. Here, Munsell value is a value describing a color by categorizing the color into three attributes of “hue”, “value (or lightness)”, and “chroma”. In terms of value, there are ten levels, with 10 representing pure white and 0 representing pure black. A difference in lightness between the outer surface of the second exterior member 54 and the outer surfaces of the operation panel 18 and the first exterior member 52 including the outer side surface of the IC card reader 16 in Munsell value is preferably 5 or larger, more preferably 5.5 or larger, and still more preferably 6 or larger.

In the first exemplary embodiment, the color of the operation panel 18 (for example, the color of the housing 18A and the operation surface 18B) is black or gray. The color of the first exterior member 52 including the outer side surface of the IC card reader 16 is black or gray so as to be similar to the color of the operation panel 18. The color of the second exterior member 54 is white or a light color with higher lightness than the color of the operation panel 18 (for example, the color of the housing 18A and the operation surface 18B).

The wall surface 56 of the discharge section 26 includes, as described previously, the upper surface 22C of the housing 22, the inner side surface 25A of the side portion 24A, the front side surface 25B of the rear surface portion 24B, and the sheet tray 44. In the first exemplary embodiment, the color of the wall surface 56 of the discharge section 26 is similar to the color of the first exterior member 52. The color of the second exterior member 54 is different from the color of the wall surface 56 of the discharge section 26. As an example, the color of the wall surface 56 of the discharge section 26 is black or gray. A medium P such as a sheet having a high lightness in Munsell value is discharged to the sheet tray 44 and hence, the medium P discharged to the sheet tray 44 is easily visually recognized.

As described above, the third exterior member 58 is provided adjacent to the discharge section 26 on the rear surface portion 24B on the rear side of the discharge section 26 in the depth direction (D direction) in the side surface of the body portion 12, and the color of the third exterior member 58 is similar to the color of the second exterior member 54.

In the first exemplary embodiment, the third exterior member 58 is provided in a range from the position adjacent to the discharge section 26 in the rear surface portion 24B to the intermediate portion of the side surface 22B on the right side of the housing 22 in the width direction (W direction), and the entire third exterior member 58 has an identical color.

The color of the second exterior member 54 is similar to the color of an outer surface 62 of the automatic document feeding section 34 above the inclined portion 42. In addition, the color of the second exterior member 54 is similar to the color of the front surface 22A and the color of the side surface 22B on the right side in the width direction (W direction), which are examples of the outer surfaces below the discharge section 26. In the first exemplary embodiment, the second exterior member 54 is integrally formed up to the front surface 22A of the housing 22, and the entire outer surface of the second exterior member 54 is formed to have an identical color. In addition, in the first exemplary embodiment, the third exterior member 58 is integrally formed up to the side surface 22B on the right side of the housing 22 in the width direction (W direction), and the entire outer surface of the third exterior member 58 is formed to have an identical color.

In addition, in the first exemplary embodiment, there is a region 74 that has a color similar to the color of the first exterior member 52. The region 74 straddles the dividing line 43 that divides the image input section 36 and the automatic document feeding section 34 in the inclined portion 42. In the first exemplary embodiment, there is the region 74 in a portion of the automatic document feeding section 34. Furthermore, in the first exemplary embodiment, in the document reading device 14, the document discharge section 38, a portion below the gripping portion 70 of the automatic document feeding section 34, and a portion below the edge portion 72 on the front side of the document placement section 32 in the depth direction (D direction) have colors similar to the color of the first exterior member 52.

As an example, in the image forming system 10, the first exterior member 52, other portions of the housing 22 excluding the upper surface 22C of the housing 22, and outer surfaces of the plurality of medium accommodation sections 104 (that is, the color of the general portion of the body portion 12) are white or a light color with higher lightness than the color of the operation panel 18. Therefore, in the image forming system 10, a collective range including the operation panel 18, the first exterior member 52 including the outer side surface of the IC card reader 16, the wall surface 56 of the discharge section 26, the region 74 of the automatic document feeding section 34 is unified in a deep color or a dark color, which is a color different from the color of the general portion of the body portion 12.

[Configuration and the like of Image Forming System of First Comparative Example]

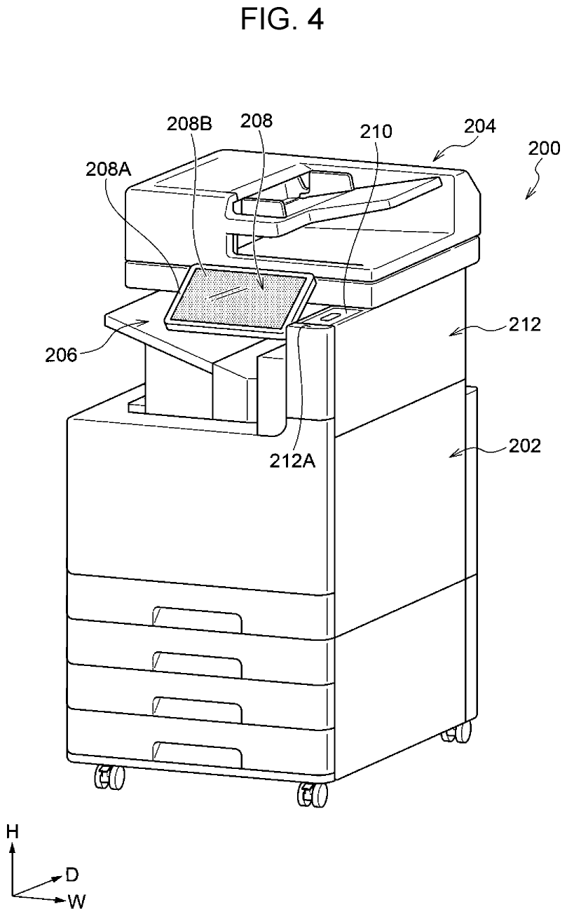

Here, an image forming system 200 according to a first comparative example will be described with reference to FIG. 4.

As illustrated in FIG. 4, the image forming system 200 according to the first comparative example includes a body portion 202 and a document reading device 204 provided on the upper side of the body portion 202. The body portion 202 is provided with a support portion 212 extending upward, and the document reading device 204 is supported by the support portion 212. The support portion 212 is provided along the depth direction (D direction) on the right side of the body portion 202 in the width direction (W direction).

Although not illustrated, the body portion 202 includes an image forming section that forms an image on a medium. The image forming system 200 includes a medium discharge section 206 on the left side of the support portion 212 in the width direction (W direction) between the document reading device 204 and the body portion 202, in a state where the body portion 202 is viewed from the front side. A medium on which an image is formed by the image forming section of the body portion 202 is discharged to the medium discharge section 206. An operation panel 208 is provided on the front side of the document reading device 204. The operation panel 208 is supported by the document reading device 204 in a state of being inclined with a rising gradient from the front side toward the deep side in the depth direction (D direction).

An upper end portion of the support portion 212 is provided with a flat surface portion 212A, an upper surface of which is disposed along the horizontal direction on the front side of the document reading device 204 in the depth direction (D direction). The flat surface portion 212A is provided with an IC card reader 210. That is, the IC card reader 210 is provided along the horizontal direction. The IC card reader 210 is provided at a position lower than the upper end portion of the operation panel 208.

The operation panel 208 includes a housing 208A and an operation surface 208B provided on a surface of the housing 208A. As an example, the operation surface 208B is black or gray. In addition, as an example, the housing 208A is white or a light color with higher lightness than the color of the operation surface 208B.

The body portion 202 including the support portion 212 is white or a light color with higher lightness than the color of the operation surface 208B. The IC card reader 210 is provided in the support portion 212 having a light color with higher lightness than the color of the operation surface 208B. As an example, the IC card reader 210 has a light color with higher lightness than the color of the operation surface 208B.

In the image forming system 200 according to the first comparative example, the IC card reader 210 is provided at a position lower than the upper end portion of the operation panel 208 and hence, the relationship between the IC card reader 210 and the operation panel 208 appears weak.

In general, in a multifunction peripheral for office use, user authentication is performed by using an IC card in some cases in order to grasp a user and a use status. In order to efficiently use an installation space for an IC card in a multifunction peripheral, the number of cases in which an IC card reader is incorporated in a body portion is increasing. In a case where an IC card reader is incorporated in a body portion, if the positions of an operation panel and the IC card reader are separated from each other or if colors or shapes of the operation panel and the IC card reader are different from each other, the relationship between the operation panel and the IC card reader becomes weak, making it difficult to recognize a touch position of the IC card reader, which becomes a problem.

In the image forming system 200 according to the first comparative example, the IC card reader 210 is provided at a position lower than the upper end portion of the operation panel 208. In addition, the operation surface 208B of the operation panel 208 and the support portion 212 in which the IC card reader 210 is provided have different colors. Therefore, the relationship between the IC card reader 210 and the operation panel 208 appears weak, making it difficult to recognize a touch surface of the IC card reader 210, which becomes a problem. Note that, even in a case where the IC card reader 210 is colored in black or gray, the IC card reader 210 is provided at a position lower than the upper end portion of the operation panel 208 and hence, the relationship between the IC card reader 210 and the operation panel 208 appears weak, making it difficult to recognize the touch surface of the IC card reader 210.

### [Configuration and the Like of Image Forming System of Second Comparative Example]

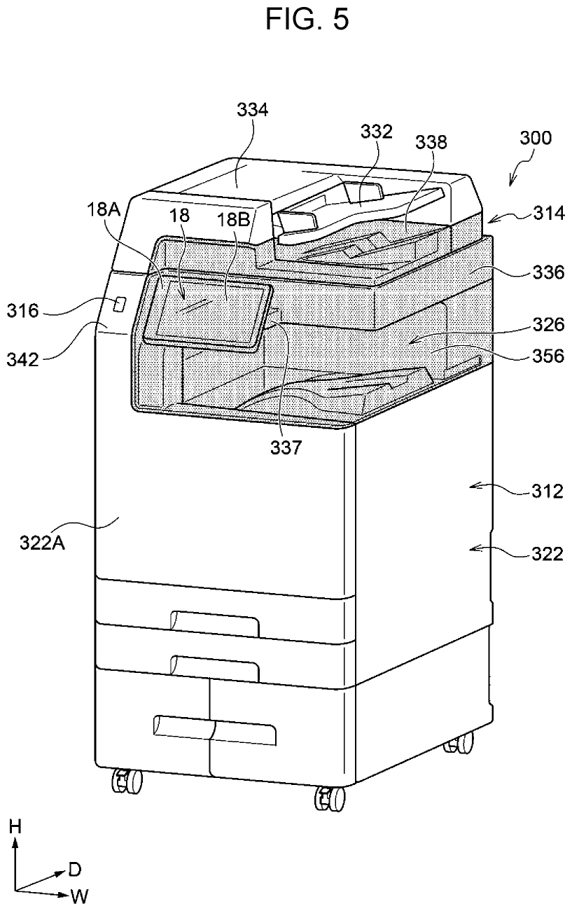

Next, an image forming system 300 according to a second comparative example will be described with reference to FIG. 5. Note that configurations similar to those in the image forming system 10 according to the first exemplary embodiment are denoted by the same reference numerals as those in the first exemplary embodiment, and description thereof will be omitted.

As illustrated in FIG. 5, the image forming system 300 according to the second comparative example includes a body portion 312 and a document reading device 314 provided on the upper side of the body portion 312. The document reading device 314 includes a document placement section 332, an automatic document feeding section 334, an image input section 336, and a document discharge section 338. Furthermore, the image forming system 300 includes an IC card reader 316 provided in an inclined portion 342 that straddles the body portion 312 and the image input section 336. In addition, the image forming system 300 is provided with the operation panel 18 on the front side of the image input section 336. Furthermore, the image forming system 300 is provided with a discharge section 326 on the lower side of the image input section 336 in the body portion 312. A medium on which an image is formed by an image forming section (not illustrated) of the body portion 312 is discharged to the discharge section 326.

The inclined portion 342 is inclined with a rising gradient from the front side that corresponds to a front surface 322A of a housing 322 in the body portion 312 toward the rear side (that is, the deep side in the depth direction). The operation panel 18 is supported by a support portion 337 provided on the front side of the image input section 336. In a state of being viewed from the front side of the body portion 312, the operation panel 18 is provided at a position adjacent to the IC card reader 316 provided in the inclined portion 342. The operation surface 18B of the operation panel 18 is inclined with a rising gradient from the front side that corresponds to the front surface 322A of the housing 322 in the body portion 312 toward the rear side (that is, the deep side in the depth direction). The operation surface 18B of the operation panel 18 is positioned on the deep side in the depth direction (D direction) with respect to the outer side surface of the IC card reader 316, and there is a step between the operation surface 18B of the operation panel 18 and the outer side surface of the IC card reader 316.

In the image forming system 300, the color of the operation panel 18 is black or gray, and the color of the outer side surface of the IC card reader 316 provided in the inclined portion 342 is different from the color of the operation panel 18. The color of the inclined portion 342 including the outer side surface of the IC card reader 316 is white or a light color with higher lightness than the color of the operation panel 18.

In addition, in the image forming system 300, the color of a wall surface 356 of the discharge section 326 is similar to the color of the operation panel 18. In addition, a region of the image input section 336 from the deep side of the operation panel 18 in the depth direction (D direction) to the right side in the width direction (W direction), the document discharge section 338, and a portion (a region connected to the document discharge section 338) of the automatic document feeding section 334 on the deep side of the operation panel 18 in the depth direction (D direction) have colors similar to the color of the operation panel 18.

In the image forming system 300, the color of the outer side surface of the IC card reader 316 provided in the inclined portion 342 and the color of the operation panel 18 are different from each other. In addition, the operation surface 18B of the operation panel 18 is positioned on the deep side in the depth direction (D direction) with respect to the outer side surface of the IC card reader 316 provided in the inclined portion 342, and there is a step between the outer side surface of the IC card reader 316 and the operation surface 18B of the operation panel 18. Therefore, the relationship between the IC card reader 316 and the operation surface 18B of the operation panel 18 becomes weak, making it difficult to recognize a touch surface of the IC card reader 316, which becomes a problem.

### [Operations of First Exemplary Embodiment]

Next, operations of the first exemplary embodiment will be described.

As illustrated in FIGS. 1 and 2, the image forming system 10 includes the body portion 12 and the document reading device 14 including the image input section 36. The image forming system 10 includes the inclined portion 42 that straddles the body portion 12 and the image input section 36. The inclined portion is inclined with a rising gradient from the front side that corresponds to the front surface 22A of the body portion 12 toward the rear side. The inclined portion 42 is provided with the IC card reader 16. Furthermore, the image forming system 10 includes the operation panel 18 on the front side of the image input section 36. The operation panel 18 is disposed at a position adjacent to the IC card reader 16 in the width direction (W direction). The operation surface 18B of the operation panel 18 is disposed along the outer side surface of the IC card reader 16, and the color of the operation panel 18 is similar to the color of the outer side surface of the IC card reader 16.

Therefore, the relationship between the IC card reader 16 and the operation panel 18 appears strong, making it easier to recognize the touch position of the IC card reader 16. Therefore, the image forming system 10 can intuitively convey to the user the area where user operation is required, compared to a case where the IC card reader that reads information from an IC card is positioned lower than the operation panel and the color of the outer side surface of the IC card reader and the color of the operation panel are different from each other. Here, “convey” includes not only “convey” positively but also nuances such as “make him/her grasp”, “make him/her understand”, or “make him/her feel”.

In addition, in the image forming system 10, the first exterior member 52 including the outer side surface of the IC card reader 16 has a color similar to the color of the operation panel 18 including the operation surface 18B. Therefore, the image forming system 10 can be easily manufactured, compared to a case where only the color of the outer side surface of the IC card reader is similar to the color of the operation panel.

In addition, in the image forming system 10, the IC card reader 16 and the operation panel 18 are arranged in this order from left to right on the upper side of the body portion 12 in a state of being viewed from the front side of the body portion 12. Furthermore, the image forming system 10 is configured such that a series of operations for reading information from an IC card by the IC card reader 16, selecting a job by using the operation panel 18, and executing the job are performed from left to right. Therefore, the image forming system 10 makes it easier for the user to intuitively grasp the flow of the operations, compared to a case where the IC card reader and the operation panel are disposed at positions displaced from each other in the depth and width directions of the apparatus.

In addition, the image forming system 10 includes the discharge section 26 on the lower side of the image input section 36 in the upper portion of the body portion 12. A medium P on which an image is formed by the image forming section 102 is discharged to the discharge section 26. In a state of being viewed from the front side of the body portion 12, the take-out opening 46 where the medium P is taken out from the discharge section 26 is formed on the right side of the operation panel 18 in the width direction (W direction). Therefore, the image forming system 10 makes it easier to perform a series of operations for reading information from an IC card by the IC card reader 16, selecting a job by using the operation panel 18, executing the job, and taking out the medium P from the take-out opening 46 of the discharge section 26 from left to right, compared to a case where the take-out opening of the discharge section is provided on the left side of the operation panel and the IC card reader in a state of being viewed from the front side of the body portion.

In addition, in the image forming system 10, the first exterior member 52 including the outer side surface of the IC card reader 16 has a color similar to the color of the operation panel 18 including the operation surface 18B. Furthermore, in a state of being viewed from the front side of the body portion 12, the second exterior member 54 is provided at a position adjacent to the left side of the first exterior member 52 in the width direction (W direction), and the color of the second exterior member 54 is different from the color of the first exterior member 52. Therefore, in the image forming system 10, the entire housing of the image forming system 10 is more likely to appear compact in the width direction while user operation areas are unified in similar colors, compared to a case where the second exterior member and the first exterior member have an identical color.

In addition, in the image forming system 10, the color of the wall surface 56 of the discharge section 26 is similar to the color of the first exterior member 52, and the color of the second exterior member 54 is different from the color of the wall surface 56 of the discharge section 26. Therefore, in the image forming system 10, the entire housing of the image forming system 10 is more likely to appear compact in the width direction while user operation areas are unified in similar colors, compared to a case where the color of the second exterior member is the same as the color of the first exterior member and the color of the wall surface of the discharge section.

In addition, in the image forming system 10, the third exterior member 58 is provided adjacent to the discharge section 26 on the rear side of the discharge section 26 in the depth direction (D direction) in the side surface of the body portion 12, and the color of the third exterior member 58 is similar to the color of the second exterior member 54. Therefore, in the image forming system 10, the entire housing of the image forming system 10 is more likely to appear compact as viewed obliquely from the front side while user operation areas are unified in similar colors, compared to a case where the color of the third exterior member is the same as the color of the first exterior member and the color of the discharge section.

In addition, in the image forming system 10, the color of the second exterior member 54 is similar to the color of the outer surface 62 of the automatic document feeding section 34 above the inclined portion 42 and the color of the outer surface of the body portion 12 below the discharge section 26. Therefore, in the image forming system 10, the entire housing of the image forming system 10 is more likely to appear compact in the width direction while user operation areas are unified in similar colors, compared to a case where the color of the second exterior member is different from the color of the outer surface above the inclined portion and the color of the outer surface below the discharge section.

In addition, in the image forming system 10, the color of the first exterior member 52 and the color of the operation panel 18 are black or gray, and the color of the second exterior member 54 is white or a light color with higher lightness than the color of the first exterior member 52 and the color of the operation panel 18. Therefore, in the image forming system 10, the entire housing of the image forming system 10 is more likely to appear compact in the width direction while user operation areas are unified in similar colors, compared to a case where the color of the second exterior member is white and the color of the first exterior member is a light color. In addition, in the image forming system 10, the entire housing of the image forming system 10 is more likely to appear compact in the width direction while user operation areas are unified in similar colors, compared to a case where the color of the second exterior member is white and the color of the first exterior member and the color of the wall surface of the discharge section are light colors.

In addition, the image forming system 10 includes the automatic document feeding section 34 that feeds the document placed on the document placement section 32 to the document discharge section 38 via the image input section 36. The automatic document feeding section 34 is disposed on the upper side of the body portion 12 in the up-down direction. In addition, there is the region 74 that has a color similar to the color of the first exterior member 52. The region 74 straddles the dividing line 43 that divides the image input section 36 and the automatic document feeding section 34 in the inclined portion 42. Therefore, the image forming system 10 makes it easier for the user to recognize a portion to perform an operation, compared to a case where the automatic document feeding section side with respect to the dividing line as a boundary is colored in a color different from the color of the first exterior member.

In addition, in the image forming system 10, the automatic document feeding section 34 is configured to be openable and closable between a position in which the input unit that receives an image to be input to the image input section 36 is closed and a position in which the input unit is opened. Furthermore, the front side of the automatic document feeding section 34 is provided with the gripping portion 70 that is capable of being gripped when a user opens the automatic document feeding section 34. The gripping portion 70 and the edge portion 72 on the front side of the automatic document feeding section 34 are continuously connected in a linear shape. Therefore, the image forming system 10 makes it easier for the user to recognize a portion to perform an operation, compared to a case where the gripping portion is separated from the front portion of the automatic document feeding section.

### Others

In the above first exemplary embodiment, the color of the outer side surface of the IC card reader 16 and the color of the operation panel 18 are black or gray, but the present disclosure is not limited to this configuration. For example, as long as the color of the outer side surface of the IC card reader 16 is similar to the color of the operation panel 18, the color of the outer side surface of the IC card reader 16 and the color of the operation panel 18 can be changed.

In addition, in the first exemplary embodiment, the color of the first exterior member 52 including the outer side surface of the IC card reader 16 is black or gray, but the present disclosure is not limited to this configuration. For example, only the color of the outer side surface of the IC card reader 16 adjacent to the operation panel 18 in the width direction (W direction) may have a color similar to the color of the operation panel 18.

In addition, in the first exemplary embodiment, the color of the second exterior member 54 is white or a light color with higher lightness than the color of the first exterior member 52 and the color of the operation panel 18, but the present disclosure is not limited to this configuration. For example, as long as the color of the second exterior member 54 is different from the color of the first exterior member 52 including the outer side surface of the IC card reader 16, the color of the second exterior member 54 can be changed.

Note that the present disclosure has been described in detail with respect to a specific exemplary embodiment, but the present disclosure is not limited to the exemplary embodiment, and it is apparent to those skilled in the art that various other exemplary embodiments can be adopted within the scope of the present disclosure.

### <Preferred Mode of Present Disclosure>

### Appendix

(((1)))

An image forming system comprising:
a body portion including an image forming section that forms an image on a medium;
an image input section that inputs an image, the image input section being provided on an upper side of the body portion in an up-down direction;
a reading section that reads information stored in a storage medium, the reading section being provided in an inclined portion that straddles the body portion and the image input section, the inclined portion being inclined with a rising gradient from a front side that corresponds to a front surface of the body portion toward a rear side; and
an operation section that receives an operation by an operator, the operation section being disposed at a position adjacent to the reading section with an operation surface disposed along an outer side surface of the reading section, the operation section having a color similar to a color of the outer side surface of the reading section.
   (((2)))

The image forming system according to (((1))), wherein a first exterior member including the outer side surface of the reading section has a color similar to the color of the operation section including the operation surface.

(((3)))

The image forming system according to (((1))), wherein
the reading section and the operation section are arranged in an order from left to right on an upper side of the body portion in a state of being viewed from a front side of the body portion, and
the image forming system is configured such that a series of operations for reading information from the storage medium by the reading section, selecting a job by using the operation section, and executing the job are performed from left to right.
   (((4)))

The image forming system according to (((3))), comprising a discharge section on a lower side of the image input section in an upper portion of the body portion, the medium on which an image is formed by the image forming section is discharged to the discharge section, wherein
a take-out opening where the medium is taken out from the discharge section is formed on a right side of the operation section in the state of being viewed from the front side of the body portion.
   (((5)))

The image forming system according to (((2))), wherein
a first exterior member including the outer side surface of the reading section has a color similar to the color of the operation section including the operation surface,
a second exterior member is provided at a position adjacent to a left side of the first exterior member in a state of being viewed from a front side of the body portion, and
a color of the second exterior member is different from the color of the first exterior member.
   (((6)))

The image forming system according to (((4))), wherein
a first exterior member including the outer side surface of the reading section has a color similar to the color of the operation section including the operation surface,
a second exterior member is provided at a position adjacent to a left side of the first exterior member in the state of being viewed from the front side of the body portion, and
a color of the second exterior member is different from the color of the first exterior member.
   (((7)))

The image forming system according to (((6))), wherein
a color of a wall surface of the discharge section is similar to the color of the first exterior member, and
the color of the second exterior member is different from the color of the wall surface of the discharge section.
   (((8)))

The image forming system according to (((7))), wherein
a third exterior member is provided adjacent to the discharge section on a rear side of the discharge section in a depth direction in a side surface of the body portion, and
a color of the third exterior member is similar to the color of the second exterior member.
   (((9)))

The image forming system according to (((6))), wherein the color of the second exterior member is similar to a color of an outer surface above the inclined portion and a color of an outer surface below the discharge section.

(((10)))

The image forming system according to (((5))), wherein
the color of the first exterior member and the color of the operation section are black or gray, and
the color of the second exterior member is white or a light color having higher lightness than the color of the first exterior member and the color of the operation section.
   (((11)))

The image forming system according to (((9))), wherein
the color of the first exterior member and the color of the operation section are black or gray, and
the color of the second exterior member is white or a light color having higher lightness than the color of the first exterior member and the color of the operation section.
   (((12)))

The image forming system according to (((2))), comprising a document feeding device that feeds a document placed on a document placement section to a document discharge section via the image input section, the document feeding device being provided on the upper side of the body portion in the up-down direction, wherein
there is a region that has a color similar to the color of the first exterior member, the region straddling a dividing line that divides the image input section and the document feeding device in the inclined portion.
   (((13)))

The image forming system according to (((12))), wherein
the document feeding device is configured to be openable and closable between a position in which an input unit that receives an image to be input to the image input section is closed and a position in which the input unit is opened,
a front side of the document feeding device is provided with a gripping portion that is capable of being gripped when an operator opens the document feeding device, and
the gripping portion and an edge portion on the front side of the document placement section are continuously connected in a linear shape.

What is claimed is:

1. An image forming system comprising:
a body portion including an image forming section that forms an image on a medium;
an image input section that inputs an image, the image input section being provided on an upper side of the body portion in an up-down direction;
a reading section that reads information stored in a storage medium, the reading section being provided in an inclined portion that straddles the body portion and the image input section, the inclined portion being inclined with a rising gradient from a front side that corresponds to a front surface of the body portion toward a rear side; and
an operation section that receives an operation by an operator, the operation section being disposed at a position adjacent to the reading section with an operation surface disposed along an outer side surface of the reading section, the operation section having a color similar to a color of the outer side surface of the reading section.

2. The image forming system according to claim 1, wherein a first exterior member including the outer side surface of the reading section has a color similar to the color of the operation section including the operation surface.

3. The image forming system according to claim 1, wherein
the reading section and the operation section are arranged in an order from left to right on an upper side of the body portion in a state of being viewed from a front side of the body portion, and
the image forming system is configured such that a series of operations for reading information from the storage medium by the reading section, selecting a job by using the operation section, and executing the job are performed from left to right.

4. The image forming system according to claim 3, comprising a discharge section on a lower side of the image input section in an upper portion of the body portion, the medium on which an image is formed by the image forming section is discharged to the discharge section, wherein
a take-out opening where the medium is taken out from the discharge section is formed on a right side of the operation section in the state of being viewed from the front side of the body portion.

5. The image forming system according to claim 2, wherein
a first exterior member including the outer side surface of the reading section has a color similar to the color of the operation section including the operation surface,
a second exterior member is provided at a position adjacent to a left side of the first exterior member in a state of being viewed from a front side of the body portion, and
a color of the second exterior member is different from the color of the first exterior member.

6. The image forming system according to claim 4, wherein
a first exterior member including the outer side surface of the reading section has a color similar to the color of the operation section including the operation surface,
a second exterior member is provided at a position adjacent to a left side of the first exterior member in the state of being viewed from the front side of the body portion, and
a color of the second exterior member is different from the color of the first exterior member.

7. The image forming system according to claim 6, wherein
a color of a wall surface of the discharge section is similar to the color of the first exterior member, and
the color of the second exterior member is different from the color of the wall surface of the discharge section.

8. The image forming system according to claim 7, wherein
a third exterior member is provided adjacent to the discharge section on a rear side of the discharge section in a depth direction in a side surface of the body portion, and
a color of the third exterior member is similar to the color of the second exterior member.

9. The image forming system according to claim 6, wherein the color of the second exterior member is similar to a color of an outer surface above the inclined portion and a color of an outer surface below the discharge section.

10. The image forming system according to claim 5, wherein
the color of the first exterior member and the color of the operation section are black or gray, and
the color of the second exterior member is white or a light color having higher lightness than the color of the first exterior member and the color of the operation section.

11. The image forming system according to claim 9, wherein
the color of the first exterior member and the color of the operation section are black or gray, and
the color of the second exterior member is white or a light color having higher lightness than the color of the first exterior member and the color of the operation section.

12. The image forming system according to claim 2, comprising a document feeding device that feeds a document placed on a document placement section to a document discharge section via the image input section, the document feeding device being provided on the upper side of the body portion in the up-down direction, wherein
there is a region that has a color similar to the color of the first exterior member, the region straddling a dividing line that divides the image input section and the document feeding device in the inclined portion.

13. The image forming system according to claim 12, wherein
the document feeding device is configured to be openable and closable between a position in which an input unit that receives an image to be input to the image input section is closed and a position in which the input unit is opened,
a front side of the document feeding device is provided with a gripping portion that is capable of being gripped when an operator opens the document feeding device, and
the gripping portion and an edge portion on the front side of the document placement section are continuously connected in a linear shape.
